(19) United States
(12) Patent Application Publication
(10) Pub. No.: US 2016/0337145 A1
(43) Pub. Date: Nov. 17, 2016

(54) INTENT-BROADCAST SYSTEMS AND METHODS

(71) Applicant: Google Inc., Mountain View, CA (US)

(72) Inventors: Yi Cui, Palo Alto, CA (US); Subir Jhanb, Sunnyvale, CA (US)

(21) Appl. No.: 15/155,851

(22) Filed: May 16, 2016

Related U.S. Application Data
(60) Provisional application No. 62/161,796, filed on May 14, 2015.

(51) Int. Cl. H04L 12/28; H04L 29/08

(52) U.S. Cl. CPC H04L 12/2818; H04L 67/125; H04L 12/2834; H04L 67/2823; H04L 2012/2841

(57) ABSTRACT

In an example implementation of the disclosed technology, a method includes receiving, at a processor, an indication of a user intent, the user intent indicative of an intent of a user to control a functionality of a receiving device in wireless communication with the computing device. The method also includes serializing at least a portion of data representing the indication of the user intent into a text bundle. The method also includes generating a message configured to control the functionality of the receiving device according to the user intent, the message comprising at least the text bundle. Finally, the method includes transmitting the message for delivery to the receiving device.

### CROSS-REFERENCE TO RELATED APPLICATION

This application claims priority to and the benefit of U.S. Provisional Patent Application Ser. No. 62/161,796, which was filed on May 14, 2015, under 35 USC 119(e). The entire contents and substance of the aforementioned application are hereby incorporated by reference its entirety as if fully set forth herein.

### BACKGROUND

Application developers can create applications that allow a computing device (e.g., a mobile computing device) to control functionalities of another computing device (e.g., a smart television, a smart home hub). Thus, a user can control the volume on a smart television using a smart phone. The user's commands (i.e., intents), such us turn up the volume or turn off the lights, can be transmitted in the form of a message from the computing device to an application server provided by the application developer. The application server can be in communication with a separate server (not provided by the application developer) that further transmits the user's intent to the intended receiving devices. Thus, an application developer can provide both the application and the upstream (i.e., device-to-server) infrastructure for sending an intent. A separate provider then provides the downstream (i.e., server-to-device) infrastructure for delivering the intent.

### SUMMARY

Some or all of the above needs may be addressed by certain implementations of the disclosed technology. According to an example implementation, a method is provided. In an example implementation of the disclosed technology, a method includes receiving, at a computing device, an indication of a user intent, the user intent indicative of an intent of a user to control a functionality of a receiving device in wireless communication with the computing device. The method also includes serializing at least a portion of data representing the indication of the user intent into a text bundle. The method also includes generating a message configured to control the functionality of the receiving device according to the user intent, the message comprising at least the text bundle. Finally, the method includes transmitting the message for delivery to the receiving device.

According to an example implementation, a system is provided. The system may include one or more processors and a memory coupled to the one or more processors and storing instructions that, when executed by the one or more processors, cause the system to: receive an indication of a user intent, the user intent indicative of an intent of a user to control a functionality of a receiving device in wireless communication with the computing device; serialize at least a portion of data representing the indication of the user intent into a text bundle, the data comprising at least an identification of the receiving device and an instruction for implementing the user intent; generate a message configured to control the functionality of the receiving device according to the user intent, the message comprising at least the text bundle; and transmit, for delivery to the receiving device, the message.

According to an example implementation, a computer-readable medium is provided. The computer-readable medium may store instructions that, when executed by one or more processors, cause a first computing device to: receive an indication of a user intent, the user intent indicative of an intent of a user to control a functionality of a receiving device in wireless communication with the computing device; serialize at least a portion of data representing the indication of the user intent into a text bundle, the data comprising at least an identification of the receiving device and an instruction for implementing the user intent; generate a message configured to control the functionality of the receiving device according to the user intent, the message comprising at least the text bundle; and transmit, for delivery to the receiving device, the message.

Other implementations, features, and aspects of the disclosed technology are described in detail herein and are considered a part of the claimed disclosed technology. Other implementations, features, and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 is a block diagram of an illustrative computer system architecture 100, according to an example implementation.

FIG. 2 is an overview of an intent broadcast system environment 200 illustrating various components that may be utilized in an intent broadcast system, according to an example implementation.

FIG. 3 is an illustrative sending device 206 and receiving device 240, according to an example implementation.

FIG. 4 is a flow diagram of a method 400 according to an example implementation.

### DETAILED DESCRIPTION

In various examples, computing devices in general, and mobile computing devices in particular, often include applications that allow a user to utilize the computing device to control another computing device. So, for example, a user can utilize his mobile computing device to adjust the temperature in his smart home hub-enabled house. In the foregoing example, the user's mobile device can be characterized as a sending device, and the smart home hub can be characterized as a receiving device. In another example, a user can use her mobile device (i.e., sending device) to change the volume on her smart television (receiving device).

In such examples, in addition to the application itself, an application developer typically provides an application server. Generally, the application server communicates with a separate server (not provided by the application developer) that is in communication with various receiving devices. So in a typical example, the user's device transmits the user's intent (e.g., adjust the temperature, adjust the volume), in the form of a message to the application server, and the application server transmits the intent to the separate server, which delivers the intent to the intended receiving devices (e.g., the smart home hub or the smart television, respectively). Accordingly, in a conventional scenario, the application developer provides the upstream (i.e., device-to-server) infrastructure by which the user's intent is delivered to the intended receiving device. A separate server generally provides the downstream (i.e., server-to-device) infrastructure by which the user's intent is delivered to the intended receiving device.

Aspects of the disclosed technology relate to systems and methods that allow for more streamlined intent delivery. According to certain implementations of the disclosed technology, computing devices (e.g., mobile computing devices, receiving devices) can include a background messaging application (“MA”) that maintains a persistent connection to a messaging service (“MS”) executing on a server (e.g., a cloud server). In some implementations, the MS, including the MA and the MS connection, supports both upstream messages (i.e., messages sent from a sending computing device to a server) and downstream messages (i.e., messages sent from the server to a recipient computing device). Accordingly, the MS can allow sending devices to send messages and receiving devices to receive messages utilizing the same infrastructure.

In some implementations, mobile devices (e.g., sending devices, receiving devices) can include an application (an “intent marshaller/demarshaller” or “IMD”) configured to receive an intent from a sending application (e.g., home control application, television remote application). The IMD can modify (i.e., marshal) the intent such that it can be included in a message compatible with the MS. Additionally, in some implementations, an IMD can be configured to deliver an intent to a receiving application (e.g., home control application, television remote application). Similar to the marshalling capability, the IMD can modify (i.e., demarshal) the message received via the MS such that the receiving application can execute the user's intent.

As will be appreciated, an MS that supports both upstream and downstream messages between sending and receiving devices can eliminate the need for application developer-provided infrastructure, including application servers. By eliminating this need to provide infrastructure, application developers can focus instead on application development and improvement. Further, in some implementations, an IMD can be configured such that it runs within the same process as the sending and receiving applications, but separate from any application running on a sending or receiving device. As will be appreciated, such a configuration prevents the IMD from having excessive permissions beyond the scope of the application itself (i.e., the MS can provide centralized access control). Further, in some implementations, an IMD can be configured such that it does not affect the functionality of the MS and instead simply manages the courier job of packing/sending and unpacking/constructing intents such that the MS can receive and deliver the intents.

Some implementations of the disclosed technology will be described more fully hereinafter with reference to the accompanying drawings. This disclosed technology may, however, be embodied in many different forms and should not be construed as limited to the implementations set forth herein.

In the following description, numerous specific details are set forth. It is to be understood, however, that implementations of the disclosed technology may be practiced without these specific details. In other instances, well-known methods, structures and techniques have not been shown in detail in order not to obscure an understanding of this description. References to “one implementation,” “an implementation,” “example implementation,” “various implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Example implementations of the disclosed technology will now be described with reference to the accompanying figures.

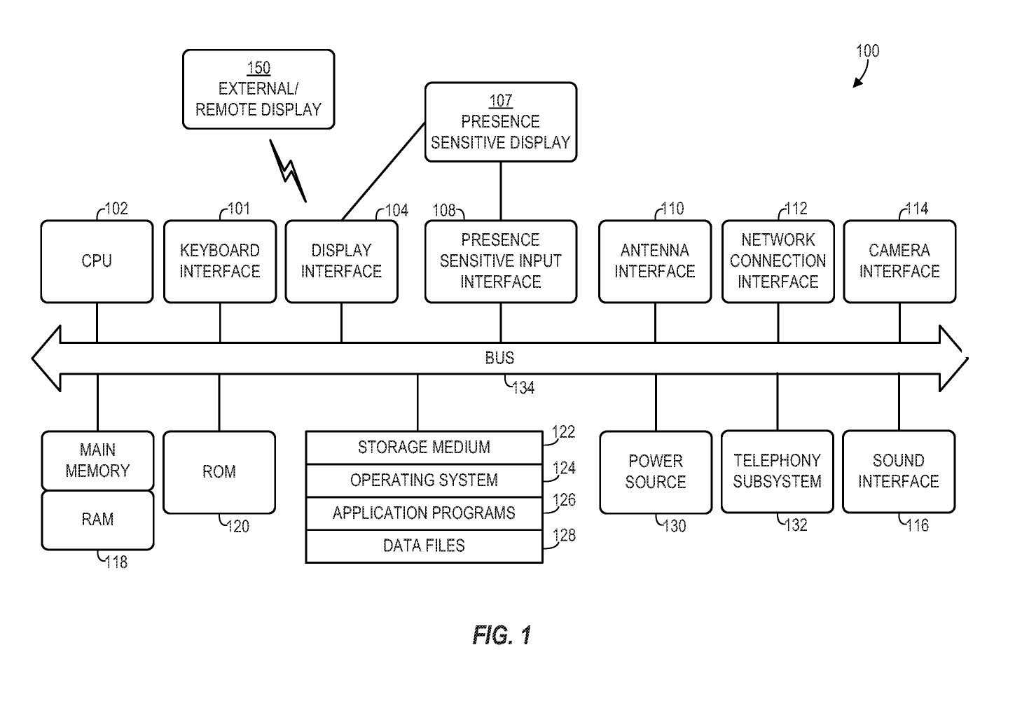

As desired, implementations of the disclosed technology may include a computing device with more or less of the components illustrated in FIG. 1. It will be understood that the computing device architecture 100 is provided for example purposes only and does not limit the scope of the various implementations of the present disclosed systems, methods, and computer-readable mediums.

The computing device architecture 100 of FIG. 1 includes a central processing unit (CPU) 102, where computer instructions are processed; a display interface 104 that acts as a communication interface and provides functions for rendering video, graphics, images, and texts on the display. In certain example implementations of the disclosed technology, the display interface 104 may be directly connected to a local display, such as a touch-screen display associated with a mobile computing device. In another example implementation, the display interface 104 may be configured for providing data, images, and other information for an external/remote display that is not necessarily physically connected to the mobile computing device. For example, a desktop monitor may be utilized for mirroring graphics and other information that is presented on a mobile computing device. In certain example implementations, the display interface 104 may wirelessly communicate, for example, via a Wi-Fi channel or other available network connection interface 112 to the external/remote display.

In an example implementation, the network connection interface 112 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof. In one example, the display interface 104 may be operatively coupled to a local display, such as a touch-screen display associated with a mobile device. In another example, the display interface 104 may be configured to provide video, graphics, images, text, other information, or any combination thereof for an external/remote display that is not necessarily connected to the mobile computing device. In one example, a desktop monitor may be utilized for mirroring or extending graphical information that may be presented on a mobile device. In another example, the display interface 104 may wirelessly communicate, for example, via the network connection interface 112 such as a Wi-Fi transceiver to the external/remote display.

The computing device architecture 100 may include a keyboard interface 106 that provides a communication interface to a keyboard. In one example implementation, the computing device architecture 100 may include a presence-sensitive display interface 108 for connecting to a presence-sensitive display 107. According to certain example implementations of the disclosed technology, the presence-sensitive display interface 108 may provide a communication interface to various devices such as a pointing device, a touch screen, a depth camera, etc. which may or may not be associated with a display.

The computing device architecture 100 may be configured to use an input device via one or more of input/output interfaces (for example, the keyboard interface 106, the display interface 104, the presence sensitive display interface 108, network connection interface 112, camera interface 114, sound interface 116, etc.,) to allow a user to capture information into the computing device architecture 100. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture 100 or may be a separate device. For example, the input device may be an accelerometer, a magnetometer, a digital camera, a microphone, and an optical sensor.

Example implementations of the computing device architecture 100 may include an antenna interface 110 that provides a communication interface to an antenna; a network connection interface 112 that provides a communication interface to a network. As mentioned above, the display interface 104 may be in communication with the network connection interface 112, for example, to provide information for display on a remote display that is not directly connected or attached to the system. In certain implementations, a camera interface 114 is provided that acts as a communication interface and provides functions for capturing digital images from a camera. In certain implementations, a sound interface 116 is provided as a communication interface for converting sound into electrical signals using a microphone and for converting electrical signals into sound using a speaker. According to example implementations, a random access memory (RAM) 118 is provided, where computer instructions and data may be stored in a volatile memory device for processing by the CPU 102.

According to an example implementation, the computing device architecture 100 includes a read-only memory (ROM) 120 where invariant low-level system code or data for basic system functions such as basic input and output (I/O), startup, or reception of keystrokes from a keyboard are stored in a non-volatile memory device. According to an example implementation, the computing device architecture 100 includes a storage medium 122 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 124, application programs 126 (including, for example, a web browser application, a widget or gadget engine, and or other applications, as necessary) and data files 128 are stored. According to an example implementation, the computing device architecture 100 includes a power source 130 that provides an appropriate alternating current (AC) or direct current (DC) to power components.

According to an example implementation, the computing device architecture 100 includes a telephony subsystem 132 that allows the device 100 to transmit and receive sound over a telephone network. The constituent devices and the CPU 102 communicate with each other over a bus 134.

According to an example implementation, the CPU 102 has appropriate structure to be a computer processor. In one arrangement, the CPU 102 may include more than one processing unit. The RAM 118 interfaces with the computer bus 134 to provide quick RAM storage to the CPU 102 during the execution of software programs such as the operating system application programs, and device drivers. More specifically, the CPU 102 loads computer-executable process steps from the storage medium 122 or other media into a field of the RAM 118 in order to execute software programs. Data may be stored in the RAM 118, where the data may be accessed by the computer CPU 102 during execution. In one example configuration, the device architecture 100 includes at least 128 MB of RAM, and 256 MB of flash memory.

The storage medium 122 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 122, which may comprise a machine-readable storage medium.

According to one example implementation, the term computing device, as used herein, may be a CPU, or conceptualized as a CPU (for example, the CPU 102 of FIG. 1). In this example implementation, the computing device (CPU) may be coupled, connected, and/or in communication with one or more peripheral devices, such as display. In another example implementation, the term computing device, as used herein, may refer to a mobile computing device such as a smartphone, tablet computer, or smart watch. In this example implementation, the computing device may output content to its local display and/or speaker(s). In another example implementation, the computing device may output content to an external display device (e.g., over Wi-Fi) such as a TV or an external computing system.

In example implementations of the disclosed technology, a computing device may include any number of hardware and/or software applications that are executed to facilitate any of the operations. In example implementations, one or more I/O interfaces may facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be utilized to receive or collect data and/or user instructions from a wide variety of input devices. Received data may be processed by one or more computer processors as desired in various implementations of the disclosed technology and/or stored in one or more memory devices.

One or more network interfaces may facilitate connection of the computing device inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

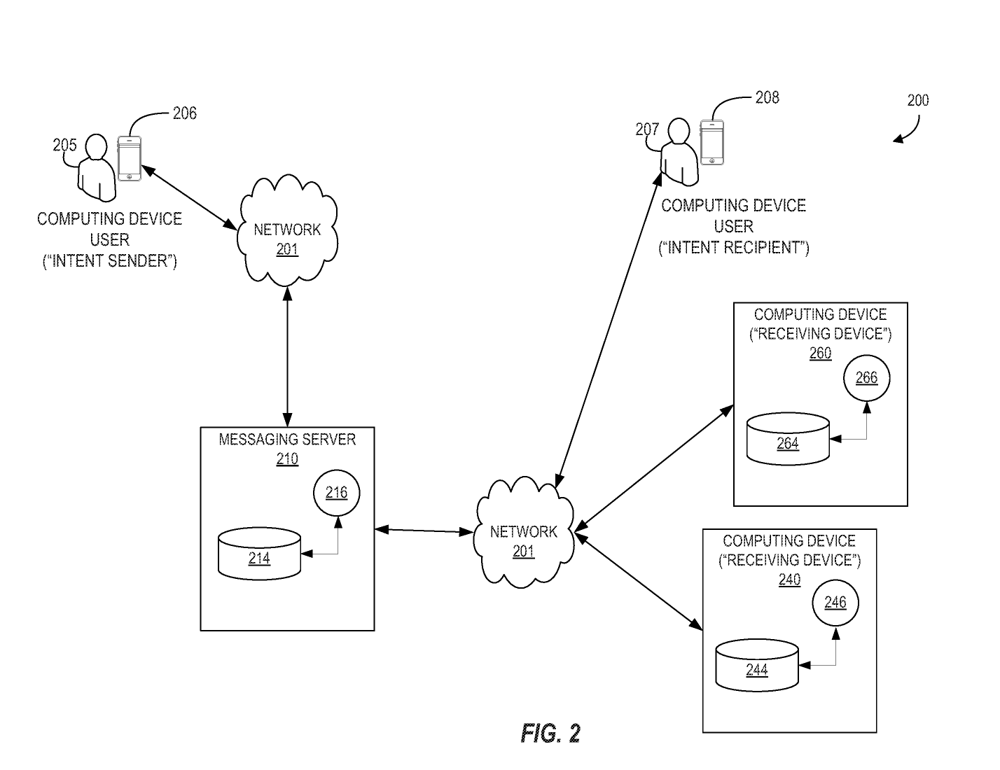

FIG. 2 is an overview of an intent broadcast system environment 200 that illustrates various components that may be included in an intent broadcast system according to the present disclosure. As shown in FIG. 2, an intent broadcast system may involve computing device users 205, 207 who may use computing devices 206 and 208 (e.g., a mobile phone, laptop computer, tablet computer, or other computing device), respectively. In some examples, computing device user 205 may be referred to as an “intent sender.” Intent sender 205 may utilize applications on his computing device 206 to control functionalities of other computing devices (e.g., 208, 260, and 240). Thus, in some examples, computing device 260, which may be referred to as a “receiving device,” may be a smart home hub. Accordingly, in some implementations, intent sender 205 may utilize an application on his computing device 206 to adjust the temperature in his house or turn on lights in his house via computing device 260 (i.e., the smart home hub). Further, in some examples, computing device 240, which may also be referred to as a “receiving device,” may be a smart television. Thus intent sender 205 may utilize an application on his computing device 206 to adjust the volume on his smart television (i.e., computing device 240).

In some examples, intent sender 205 may utilize a calendar application on his computing device 206 to cancel an appointment among all appointment invitees and among all computing devices of the invitees, including intent sender 205, that include the calendar application. Accordingly, in some implementations, the calendar application on computing device 206 may transmit an intent to cancel the appointment. Thus, if intent recipient 207 is an invitee of the cancelled appointment, computing device 208 may receive the intent such that the calendar application cancels the appointment according to the intent.

As shown in FIG. 2, an intent broadcast system environment 200 may also include messaging server 210. In some implementations, messaging server 210 can comprise database 214 and processor 216. As shown in FIG. 2, computing devices (e.g., 206, 208, 240, 260) and messaging server 210 can be operatively connected through a network 201, such as the Internet. Though not shown, many computing devices can be connected to messaging server 210. And though shown as a single messaging server 210 in FIG. 2, messaging server 210 may be replicated in many physical servers and/or may be embodied as a cloud server, and reference to a “messaging server” can be interpreted as reference to a plurality of related servers. Further, messaging servers 210 and computing devices 206, 208, 240, and 260 can include some or all of the components of the computing device 100 shown in FIG. 1, and messaging server 210 can be described as a computing system having one or more processors. Finally, in various implementations, computing devices 206, 208, 240, and 260 are access-controlled devices.

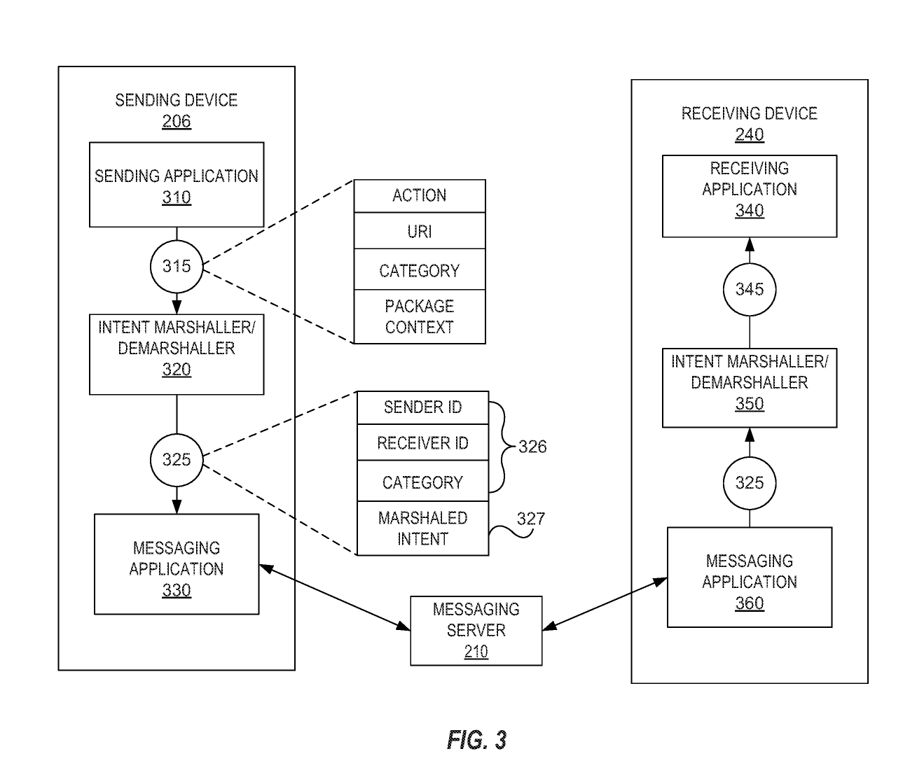

In some implementations, and as will be discussed further in relation to FIG. 3, messaging server 210 can execute a messaging service such that messaging server 210 is specifically configured to receive intents from a computing device (e.g., 206). Put differently, the intents may be specifically formatted to be compatible with messaging server 210 and the messaging service (e.g., the structure and format of the intent, and the information included as part of the intent, are formatted for and recognizable to messaging server 210). As discussed above, an intent can be a command to control a functionality of or provided by another computing device. Thus, for example, an intent can be a command to adjust the volume on a smart television or to turn off the lights in a home via a smart home hub. Further, in the case of, for example, a calendar application, an intent can be a command to cancel an appointment or meeting that propagates to other computing devices having a similar calendar application that includes the same meeting or appointment. Thus, in some implementations, messaging server 210 can be configured to receive intents from an intent sender (e.g., intent sender 205) and deliver the intents to the intended recipients (e.g., receiving device 240, receiving device 260, and computing device 208). Further, in some implementations, messaging server 210 can enforce access control between computing devices. Thus, for example, messaging server 210 can be configured such that in the case of a calendar application, the intent from the sending device can be delivered to all devices within a predefined group. Further, in the case of the remote control application, the messaging server 210 can be configured such that the sending device (e.g., 206) can send intents to more than one smart television within the user's home. Also, in some implementations, messaging server 210 can be configured to enforce asymmetric intent distribution. Thus, in the remote control application example, the sending device (e.g., 206) can send intents to all smart televisions in the user's house, but the smart televisions cannot send intents back to the sending device. In some embodiments, messaging server 210 can be configured to allow for group notification in which various computing devices can be grouped for sending and receiving intents based on defined permissions.

As will be further understood, an intent broadcast system environment 200 can comprise more or less components than shown in FIG. 2. In various implementations, messaging server 210 can be replicated across the globe to allow to allow many computing devices (e.g., 206, 208) to send and receive intents.

FIG. 3 illustrates an exemplary sending device 206 and receiving device 240, according to an example implementation. As indicated, though not shown, sending device 206 and receiving device 240 can include some or all of the components of the computing device 100 shown in FIG. 1. Additionally, as shown in FIG. 3, sending device 206 can comprise sending application 310, intent marshaller/demarshaller (IMD) 320, and messaging application 330. Similarly, as shown in FIG. 3, in some implementations receiving device 240 can comprise receiving application 340, IMD 350, which can function similarly to IMD 320, and messaging application 360, which can function similarly to messaging application 330.

In some implementations, messaging application 310 and receiving application 340 may be a pair of co-developed applications that provide a user (e.g., intent sender 205) with the ability to control the functionality of one computing device (e.g., receiving device 240) via another (e.g., sending device 206). Put differently, messaging application 310 and receiving application 340 may be two sides of the same coin: messaging application 310 receives the user's instruction and generates a deliverable intent; receiving application 340 receives the intent and executes the command. As shown in FIG. 3, in some implementations, sending application 310 translates a user's command into intent object 315. In some implementations, intent object 315 comprises various fields: action; uniform resource identifier (URI); category; and package context. Further, in some implementations, intent object 315 can further comprise fields such as type (i.e., the explicit type of the intent date, which is the data that is operated on by the action), component (i.e., the explicit name of the component class to use for the intent), or extras (i.e., a bundle of additional information relating to the intent).

In some implementations, the action describes the command or intent to be executed. Thus, in the case of a calendar application, the action can be “dismissal” (i.e., cancel an appointment). In the case of a remote control application for a smart television, the action can be “volume up” or “view” (i.e., watch a particular program or clip). In the case of a smart home hub application, the action can be “turn_up” (i.e., turn up the temperature on the thermostat). In various implementations, URI is typically a string of characters that identifies, for example, a web resource associated with the command (e.g., a URL for a clip to be shown in a smart television) or an actual resource (e.g., the receiving device (i.e., receiving device 240)).

Further, in various implementations, category can be a Java-style package string. In some embodiments, the purpose of the category is to prevent malicious apps from eavesdropping for intents. So, for example, in the case of a remote control application for a smart television, a sending application (e.g., 310) may have the category name “com.foo.smarttv.controller,” and the respective receiving application (e.g., 340) may have the category name “com.foo.smarttv.receiver.” Accordingly, in the foregoing example, the category of intent object 315, which is intended for the receiving application of an application for a smart television, may be “com.foo.smarttv.receiver.” As will be understood and appreciated, no other application (i.e., any application that does not have the category “com.foo.smarttv.receiver”) will be able to receive intent object 315. According, in some implementations, sending application 310 can be configured to generate an intent comprising a predefined category field that matches the receiving application 340, which can prevent eavesdroppers from intercepting the intent.

Likewise, in various implementations, package context can give the sender of an intent (e.g., intent object 315) tighter control over how the receiving application (e.g., 340) ultimately executes the intent upon receipt. For example, package context may specify a particular package implementation, class, or method the receiving application (e.g., 340) is supposed to execute.

As will appreciated by one of skill in the art, typical remote procedure call (RPC) mechanisms generally are insufficient for sending intents (e.g., intent object 315) from one device (e.g., sending device 206) to another (e.g., receiving device 240). In particular, typical intents (e.g., intent object 315) generally require Binder support to travel among processes. Accordingly, in some implementations, sending device 206 comprises IMD 320, which can be configured to serialize various fields of intent object 315 into a text bundle that can be included in message 325. For example, in some implementations, IMD 320 can serialize one or more of the action, URI, category, and package fields. As shown in FIG. 3, message 325 can comprise message header 326, which can include sender ID, receiver ID, and a category, in addition to marshaled intent 327 (i.e., text bundle or message payload), which can include the serialized fields from intent object 315. As will be understood by one of skill in the art, by serializing one or more of the action, URI, category, and package fields by IMD 320 can translate intent structure 315 into a format that can be stored and/or transmitted such that it can be reconstructed later (e.g., by IMD 350). Further, though shown as a separate application, it will be understood by one of skill in the art that IMD 320 or IMD 350 can be configured such that at run time, instead of running as an independent process, IMD 320 or IMD 350 runs within the same process as sending application 310 and receiving application 340, respectively, thus preventing IMD 320 or IMD 350 from having excessive permissions beyond the sending and receiving applications (i.e., 310 and 340).

As shown in FIG. 3, messaging application 330 can transmit message 325, including marshaled intent 327, to receiving device 240 via messaging server 210, where it can be received at messaging application 360. In some implementations, a messaging application (e.g., 330, 360) can be a background application that maintains a persistent connection to a messaging server (e.g., 210). As shown in FIG. 3, in some implementations, receiving device 240 can comprise IMD 350, which can be configured to receive message 325 from messaging application 360. In some implementations, IMD 350 can deserialize marshaled intent 327 and construct new intent object 345. In general, new intent object 345 can comprise fields similar to intent object 315 (i.e., action, URI, category, and package fields). Accordingly, in some implementations, IMD 350 can be configured to transmit new intent object 345 to receiving application 340 such that the intent of intent sender 205 can be carried out at receiving device 240.

As will be understood and appreciated, utilizing a messaging server 210 and messaging applications 330, 360 configured to maintain persistent connections to messaging server 210 can provide security advantages. For example, in some implementations, computing devices utilizing messaging applications such as 330 and 360 can be configured to connect to messaging server 210 via secured transport layer security (TLS) layers. In other words, in some implementations, when messaging application 330 establishes a persistent connection to messaging server 210, the connection can be established via secured TLS layers.

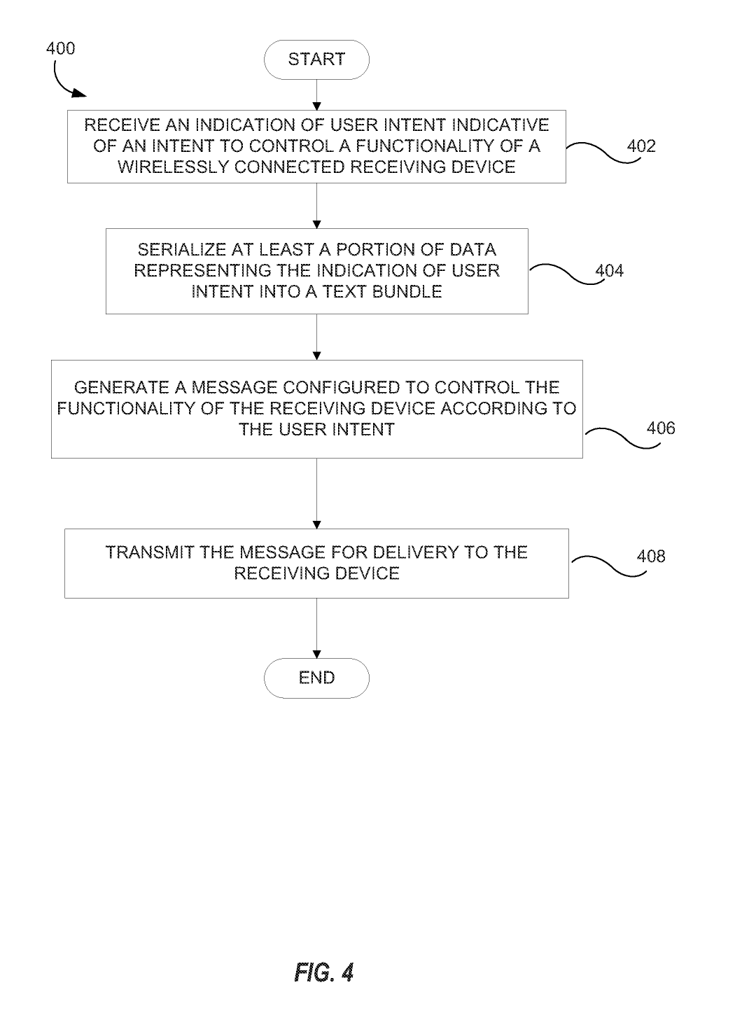

FIG. 4 is a flow diagram of a method 400 according to an example implementation of the disclosed technology. As shown, in one implementation, at 402, a computing device (e.g., sending device 206) may receive an indication of a user intent indicative of the user's intent to control a functionality of a wirelessly connected receiving device (e.g., receiving device 240). As discussed, in an example configuration, a user may utilize an application on her sending device (e.g., sending device 206) to adjust the temperature in her home via a smart home hub (e.g., receiving device 240). Accordingly, in some implementations, at 404, the receiving device (e.g., 240) may serialize at least a portion of data representing the indication of user intent into a text bundle. For example, in some implementations, the text bundle can comprise an identification of the receiving device and an instruction for implementing the user intent. Further, at 406, the computing device may generate a message configured to control the functionality of the receiving device according to the user's intent. In some implementations, the message can comprise the text bundle in addition to other information. Finally, as shown in FIG. 4, at 408, the computing device can transmit the message for delivery to the receiving device (e.g., 240).

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

Implementations of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person of ordinary skill to practice certain implementations of the disclosed technology, including making and using any devices or systems and performing any incorporated methods. The patentable scope of certain implementations of the disclosed technology is defined in the claims, and may include other examples that occur to those of ordinary skill Such other examples are intended to be within the scope of the claims if they have structural elements that do not differ from the literal language of the claims, or if they include equivalent structural elements with insubstantial differences from the literal language of the claims.

What is claimed is:

1. A method, comprising:
receiving, at a computing system having one or more processors, an indication of a user intent, the user intent indicative of an intent of a user to control a functionality of a receiving device in wireless communication with the computing device;
serializing, by the computing system, at least a portion of data representing the indication of the user intent into a text bundle, the data comprising at least an identification of the receiving device and an instruction for implementing the user intent, and the data in a format that is compatible with a messaging server executing a messaging service;
generating, by the computing system, a message configured to control the functionality of the receiving device according to the user intent, the message comprising at least the text bundle; and
transmitting, by the computing system, the message for delivery to the receiving device via the messaging server.

2. The method of claim 1, wherein at least a portion of the message is configured to be deserialized by the receiving device.

3. The method of claim 1, wherein the receiving device is a smart home hub or a smart television.

4. The method of claim 1, wherein the message further comprises a sender ID identifying the computing device and a receiver ID identifying the receiving device.

5. The method of claim 1, wherein the computing system receives the indication of the user intent from an application associated with the receiving device.

6. A non-transitory computer-readable medium storing instructions that, when executed by one or more processors, cause a computing device to:
receive an indication of a user intent, the user intent indicative of an intent of a user to control a functionality of a receiving device in wireless communication with the computing device;
serialize at least a portion of data representing the indication of the user intent into a text bundle, the data comprising at least an identification of the receiving device and an instruction for implementing the user intent;
generate a message configured to control the functionality of the receiving device according to the user intent, the message comprising at least the text bundle; and
transmit the message for delivery to the receiving device via a messaging server executing a messaging service.

7. The non-transitory computer-readable medium of claim 6, wherein at least a portion of the message is configured to be deserialized by the receiving device.

8. The non-transitory computer-readable medium of claim 6, wherein the receiving device is a smart home hub or a smart television.

9. The non-transitory computer-readable medium of claim 6, wherein the message further comprises a sender ID identifying the computing device and a receiver ID identifying the receiving device.

10. The non-transitory computer-readable medium of claim 6, wherein the data is in a format that is compatible with the messaging server executing the messaging service.

11. A system comprising:
one or more processors; and
a memory coupled to the one or more processors and storing instructions that, when executed by the one or more processors, cause the system to:
receive an indication of a user intent, the user intent indicative of an intent of a user to control a functionality of a receiving device in wireless communication with the computing device;
serialize at least a portion of data representing the indication of the user intent into a text bundle, the data comprising at least an identification of the receiving device and an instruction for implementing the user intent;
generate a message configured to control the functionality of the receiving device according to the user intent, the message comprising at least the text bundle; and
transmit the message for delivery to the receiving device via a messaging server executing a messaging service.

12. The system of claim 11, wherein at least a portion of the message is configured to be deserialized by the receiving device.

13. The system of claim 11, data is in a format that is compatible with the messaging server executing the messaging service.

14. The system of claim 11, wherein the receiving device is a smart home hub or a smart television.

15. The system of claim 11, wherein the message further comprises a sender ID identifying the computing device and a receiver ID identifying the receiving device.

16. The system of claim 11, wherein the system receives the indication of the user intent from an application associated with the receiving device.

17. The system of claim 16, wherein the application associated with the receiving device is compatible with the massaging server executing the messaging service.
